(19) United States
(12) Patent Application Publication
(10) Pub. No.: US 2018/0030286 A1
(43) Pub. Date: Feb. 1, 2018

(54) FIRE-RESISTANT WOOD PRODUCTS AND RELATED TECHNOLOGY

(71) Applicant: Weyerhaeuser NR Company, Federal Way, WA (US)

(72) Inventors: Jack Winterowd, Puyallup, WA (US); Erik Parker, Bonney Lake, WA (US); Glen D. Robak, Bonney Lake, WA (US)

(21) Appl. No.: 15/224,350

(22) Filed: Jul. 29, 2016

(51) Int. Cl. C09D 5/18; C09D 7/12; C09D 161/24

(52) U.S. Cl. CPC C09D 5/185; C09D 161/24; C09D 7/1291; C08K 3/04

(57) ABSTRACT

A composition for increasing the fire resistance of a wood product in accordance with a particular embodiment of the present technology includes intumescent particles, gas-containing elements, and a binder in which the intumescent particles and the gas-containing elements are dispersed. The composition is configured to form a coating in which the intumescent particles are present at a concentration of at least 1% by mass, and the gas-containing elements are present at a concentration of at least 0.5% by mass. The binder includes a thermosetting polymer curable from a liquid state in the composition to a solid state in the coating. In the solid state, the binder has a Young's modulus of at least 7 GPa.

### INCORPORATION BY REFERENCE

To the extent that any material incorporated herein by reference conflicts with the present disclosure, the present disclosure controls.

### TECHNICAL FIELD

The present technology is related to coatings that improve the fire resistance of wood products and related technology.

### BACKGROUND

According to the United States Fire Administration, residential and commercial fires in the United States cause over 3,000 fatalities and over $10 billion in property damage annually. These statistics underscore the importance of fire-safe construction. Specifications for fire-safe construction, which are incorporated into a variety of building codes and guidelines, indicate material types, assembly configurations, and other construction details that, when implemented, help to prevent fires and/or to mitigate fire damage. Manufactures of building products support these specifications by, among other things, producing building products that have enhanced fire resistance.

Wood products are the most common structural elements used in construction. One approach to enhancing the fire resistance of a wood product is to apply a fire-resistant coating to a surface of the wood product. Conventional fire-resistant coatings, however, have significant limitations. For example, although conventional fire-resistant coatings are often effective for protecting wood products from flame spread and direct combustion, they typically have little or no effect on the time that a wood product can carry a load in a fire event. Rapid failure of a load-carrying wood product in a fire event can be highly destructive. Correspondingly, delaying this failure has the potential to save lives and to reduce property damage by giving building occupants more time to evacuate and giving fire fighters more time to contain and extinguish fires.

Another limitation is that conventional fire-resistant coatings typically have poor durability. For example, many conventional fire-resistant coatings readily peel or disintegrate when exposed to water. A damaged fire-resistant coating may be partially or entirely ineffective, yet this ineffectiveness may be undetected unless the coating is tested in a fire event. Uncertainty regarding the integrity of fire-resistant coatings after installation complicates efforts by building inspectors and others to ensure compliance with specifications for fire-safe construction. Another limitation is that many conventional fire-resistant coatings are too expensive for widespread use. For example, some conventional fire-resistant coatings require thick application weights, making the material costs associated with these coatings prohibitively high for large-area applications. For the foregoing and/or other reasons, there is a significant need for innovation in the field of fire-resistant coatings.

### BRIEF DESCRIPTION OF THE DRAWINGS

Many aspects of the present technology can be better understood with reference to the following drawings. The components in the drawings are not necessarily to scale. Instead, emphasis is placed on illustrating clearly the principles of the present technology. For ease of reference, throughout this disclosure the same reference numbers may be used to identify identical, similar, or analogous components or features of more than one embodiment of the present technology.

FIG. 1 is a transverse cross-sectional end view of a fire-resistant wood product in accordance with an embodiment of the present technology.

FIG. 2 is an enlarged transverse cross-sectional end view of a coating of the fire-resistant wood product of FIG. 1.

FIG. 3 is an enlarged transverse cross-sectional end view of a coating of a fire-resistant wood product in accordance with another embodiment of the present technology.

FIG. 4 is a flow chart illustrating a method for enhancing a fire-resistance of a wood-containing substrate in accordance with an embodiment of the present technology.

### DETAILED DESCRIPTION

Fire-resistant wood products and related compositions, methods, and systems in accordance with embodiments of the present technology can at least partially address one or more problems associated with conventional technologies whether or not such problems are stated herein. For example, fire-resistant wood products in accordance with at least some embodiments of the present technology include fire-resistant coatings that are more effective, more durable, and/or less expensive than conventional counterparts. A fire-resistant wood product in accordance with a particular embodiment includes a wood-containing substrate having a surface coated with a composition including intumescent particles and gas-containing elements within a polymeric matrix. As further explained below, the inventors have discovered, among other things, that intumescent particles and gas-containing elements have an unexpected synergy in the context of fire-resistant coatings.

Intumescent particles are particles that expand in volume (e.g., by 50 to 300 times) to provide increased thermal insulation when heated to a critical temperature (often from 150° C. to 200° C.). This expansion typically occurs very rapidly, such as over a period of less than two seconds. In some cases, the expansion of a given intumescent particle occurs so rapidly that the particle breaks free from a binder holding the particle in place. When this occurs, the fire-resistance of the coating associated with the particle is lost. This undesirable phenomenon is commonly known as “the popcorn effect.” With the goal of reducing or eliminating the popcorn effect, binders of fire-resistant coatings including intumescent particles are conventionally selected to be flexible enough to expand with the intumescent particles without rupturing. One example of a binder that tends to exhibit this behavior is a polyurethane based on polymeric methylenediphenyldiisocyanate (pMDI) and castor oil described in U.S. Pat. No. 8,458,971, which is incorporated herein by reference in its entirety. Relative to this polyurethane and other binders conventional used with intumescent particles, formaldehyde-based binders are much more brittle. Accordingly, formaldehyde-based binders, despite having some inherent fire resistance, have not conventionally been used in fire-resistant coatings that include intumescent particles.

The inventors have discovered, among other things, that including gas-containing elements with intumescent particles in fire-resistant coatings may reduce or eliminate the popcorn effect even when the fire-resistant coatings do not include a flexible binder. Thus, incorporating gas-containing elements may allow use of a binder that is more brittle than binders conventionally used with intumescent particles, but that is also more durable (e.g., tougher and/or more water resistant), more fire-resistant, cheaper, and/or has other advantages over binders conventionally used with intumescent particles. By way of theory and without wishing to be bound to any particular theory, incorporating gas-containing elements into a fire-resistant coating may cause the fire-resistant coating to reach a critical temperature of constituent intumescent particles more gradually than would otherwise be the case. This may cause the individual intumescent particles to expand more slowly and/or allow more time to elapse between expansion of neighboring intumescent particles than would otherwise be the case. These changes, in turn, may cause a binder of the coating to preferentially flex rather than fracture in response to the expansion of the intumescent particles. As another possible mechanism, the gas-containing elements may completely or partially collapse to relieve stresses associated with expansion of the intumescent particles. Another possible mechanism is that the gas-containing elements may create discontinuities that allow differential expansion to occur in some sections of the coating while other sections remain intact. One, some, or all of the foregoing mechanisms and/or other mechanisms not mentioned may be relevant to the observed synergy between intumescent particles and gas-containing elements in the context of fire-resistant coatings.

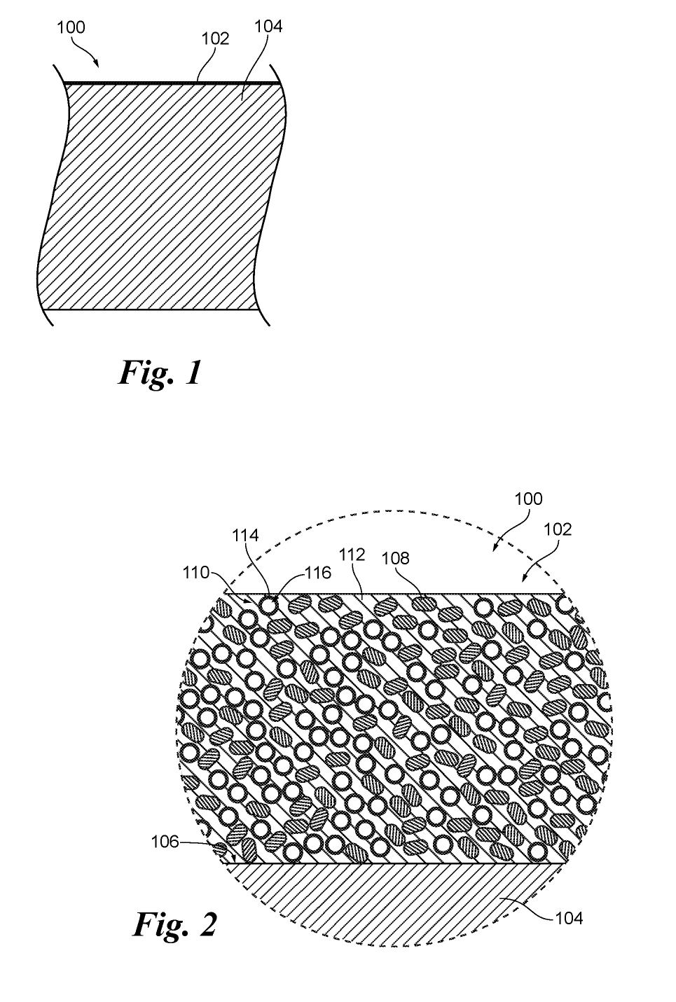

Specific details of fire-resistant wood products, compositions for increasing the fire resistance of wood products, and related products, compositions, methods, and systems in accordance with several embodiments of the present technology are described herein with reference to FIGS. 1-4. Although these embodiments may be disclosed herein primarily or entirely in the context of wood products for structural applications, other contexts in addition to those disclosed herein are within the scope of the present technology. For example, at least some features of fire-resistant wood products disclosed herein may be implemented in the context of fire-resistant products made from materials other than wood, such as gypsum, steel, aluminum, and concrete. As another example, at least some features of fire-resistant wood products for structural applications disclosed herein may be implemented in the context of fire-resistant wood products for non-structural applications. Furthermore, it should understood, in general, that other products, compositions, methods, and systems in addition to those disclosed herein are within the scope of the present technology. For example, products, compositions, methods, and systems in accordance with embodiments of the present technology can have different and/or additional configurations, components, and/or procedures than those disclosed herein. Moreover, a person of ordinary skill in the art will understand that products, compositions, methods, and systems in accordance with embodiments of the present technology can be without one or more of the configurations, components, and/or procedures disclosed herein without deviating from the present technology.

As used herein, the term “wood product” refers to a product manufactured from wood, either alone or with other materials. One example of a type of wood product is lumber, such as boards, dimensional lumber, solid-sawn lumber, joists, headers, beams, trusses, timbers, moldings, laminated lumber, finger-jointed lumber, and semi-finished lumber. Some lumber is solid wood sawn from logs, while other lumber is made by binding together strands, particles, fibers, veneers, and/or other types of wood pieces with adhesive. The latter category of wood products may be referred to herein as “composite wood products,” as a subset of all wood products. Specific examples of composite wood products include glulam, plywood, Parallam®, oriented strand board, oriented strand lumber, laminated veneer lumber, laminated strand lumber, particleboard, medium density fiberboard, cross-laminated timber, and hardboard.

FIG. 1 is a transverse cross-sectional end view of a fire-resistant wood product 100 having a coating 102 and a substrate 104 that contains wood (e.g., a wood-containing substrate) in accordance with an embodiment of the present technology. FIG. 2 is an enlarged transverse cross-sectional end view of the coating 102. With reference to FIGS. 1 and 2 together, the substrate 104 has a surface 106 underlying the coating 102. The coating 102 can have an average thickness from 1 to 6 millimeters, such as from 1 to 4 millimeters. Referring to FIG. 2, the coating 102 can include intumescent particles 108 (one identified in FIG. 2), gas-containing elements 110, and a polymeric matrix 112 in which the intumescent particles 108 and the gas-containing elements 110 are at least partially embedded. The intumescent particles 108 and the gas-containing elements 110 are shown having uniform respective appearances, uniform positions along axes perpendicular to the page, and uniform orientations about axes parallel to the page. The uniform appearances, positions, and orientations of the intumescent particles 108 and the gas-containing elements 110 are solely for ease of illustration and not intended to convey that the intumescent particles 108 and the gas-containing elements 110 necessarily have any of these uniformities.

The intumescent particles 108 can be present in the coating 102 at a concentration of at least 1% by mass (e.g. from 1% to 40% by mass), such as at least 2% by mass (e.g. from 2% to 40% by mass) or at least 5% by mass (e.g. from 5% to 40% by mass or from 5% to 20% by mass). Suitable materials for use in the intumescent particles 108 include expandable graphite, which may be graphite that has been intercalated with an acidic expansion agent (generally referred to as an “intercalant”) between parallel planes of carbon within the graphite structure. When the treated graphite is heated to a critical temperature, the reaction product of the intercalant and the graphite is gaseous and causes the graphite to undergo substantial volumetric expansion. Manufacturers of expandable graphite include GrafTech International Holding Incorporated (Parma, Ohio). Specific expandable graphite products from GrafTech include those known as Grafguard® 160-50, Grafguard® 220-50, and Grafguard® 160-80. Another domestic manufacturer of expandable graphite is HP Materials Solutions, Incorporated (Woodland Hills, Calif.). Importers of expandable graphite include Asbury Carbons (Sunbury, Pa.) and the Global Minerals Corporation (Bethesda, Md.). Other types of intumescent materials, such as vermiculite and perlite, may also be suitable for use in the intumescent particles 108 in addition to or instead of expandable graphite.

The gas-containing elements 110 can be present in the coating 102 at a concentration of at least 0.5% by mass (e.g. from 0.5% to 30% by mass), such as at least 1% by mass (e.g. from 1% to 15% by mass) or at least 3% by mass (e.g. from 3% to 15% by mass or from 3% to 10% by mass). The gas-containing elements 110 can individually have an average diameter from 10 to 200 microns. In the illustrated embodiment, the individual gas-containing elements 110 are substantially spherical hollow particles including a shell 114 and gas 116 within the shell 114. The gas 116 can be at, above, or below atmospheric pressure. In other embodiments, the individual gas-containing elements 110 can have other suitable forms. For example, counterparts of the individual gas-containing elements 110 can include porous structures (e.g., nanoporous structures) and gas within the porous structures. Suitable porous structures include porous silicate structures, porous aluminosilicate structures, halloysite nanotube structures, and aerogel structures (e.g., silica aerogel structures). Halloysite nanotubes structures are available, for example, from Applied Minerals, Inc. (New York, N.Y.). Aerogel structures are available, for example, from Cabot Corporation (Alpharetta, Ga.) and Dow Corning (Midland, Mich.). Specific aerogel products from Cabot Corporation include those known as ENOVA® and LUMIRA®. Specific aerogel products from Dow Corning include those known as VM-2260 and VM-2270.

With reference again to FIGS. 1 and 2, the gas-containing elements 110 can be very low density. For example, the gas-containing elements 110 can have a true density of at most 0.70 gram per cubic centimeter (e.g. from 0.05 to 0.70 gram per cubic centimeter), such as at most 0.60 gram per cubic centimeter (e.g. from 0.05 to 0.60 gram per cubic centimeter. The shells 114 can be made of inorganic material (e.g., glass or other ceramics) or organic material (e.g., highly crosslinked phenolic polymers). The gas 116 can be air, argon, carbon dioxide, nitrogen, or another suitable type. In at least some cases, it is useful for the gas-containing elements 110 to be non-flammable and/or to have a relatively high melt point. For example, the gas-containing elements 110 can have a melt point greater than 200° C., such as greater than 400° C. Furthermore, the gas-containing elements 110 can have a thermal conductivity from 0.03 to 0.20 watts per meter kelvin at 70° F. Manufacturers of the gas-containing elements 110 and/or suitable counterparts thereof include Potters Industries (Valley Forge, Pa.), Kish Company Inc. (Mentor, Ohio), Trelleborg Emerson & Cuming (Mansfield, Mass.), Expancel Inc. (Duluth, Ga.), Noble International SA (La Pin, France), Asia Pacific Microspheres Sdn Bhd (Selangor Darul Ehsan, Malaysia), Cenostar (Newburyport, Mass.), and Minnesota Mining and Manufacturing (St. Paul, Minn.).

The matrix 112 can be made by curing a binder component of a composition configured to form the coating 102. Suitable binders include polyurethanes, epoxies, addition polymers (e.g., acrylics, polyvinyl acetates, styrene/butadienes, and acrylonitriles), proteins (e.g., casein), polysaccharides (e.g., starch), alkyds, formaldehyde-based resins (e.g., aminoplast resins), and combinations thereof. The binder can have a liquid state and a solid state, with a significant viscosity difference between these states. In a composition configured to form the coating 102, the intumescent particles 108 and the gas-containing elements 110 can be dispersed in the binder in its liquid state. After the composition is applied to the substrate 104, the binder can be cured from its liquid state to its solid state to form the matrix 112. The matrix 112 can be present in the coating 102 at a concentration from 20% to 94% by mass. In at least some cases, the binder is a thermosetting polymer. In its solid state, the binder can be somewhat elastic, yet not thermoplastic. Furthermore, the binder in its solid state can be stiffer than conventional counterparts. The matrix 112 and the corresponding binder in its solid state can have a Young's modulus of at least 7 GPa (e.g. from 7 GPa to 12 GPa), such as at least 8 GPa (e.g. from 8 GPa to 10 GPa).

Formaldehyde-based resins are not known to be elastic. Thus, before the present technology, a person skilled in the art would have understood that this class of resins would be unsuitable for use with intumescent particles. The inventors have discovered, however, that formaldehyde-based resins may be suitable for use as the binder precursor of the matrix 112 in combination with the gas-containing elements 110. Specific examples of suitable formaldehyde-based resins include urea formaldehyde, melamine urea formaldehyde, melamine formaldehyde, benzoguanamine formaldehyde, and guanamine formaldehyde. Manufacturers of formaldehyde-based resins include the Georgia-Pacific Resins Corporation (Decatur, Ga.), Hexion Specialty Chemicals Company (Columbus, Ohio), and Arclin Performance Applied (Roswell, Ga.). As discussed above, relative to more elastic counterparts, formaldehyde-based resins tend to be more durable (e.g., tougher and/or more water resistant), more fire-resistant, cheaper, and/or to have other advantages. Furthermore, formaldehyde-based resins may be combined with other resins to enhance these and/or other desirable attributes.

The coating 102 and/or its precursor may include one or more components in addition to the intumescent particles 108, the gas-containing elements 110, and the matrix 112 or the binder precursor of the matrix 112. Examples of potentially useful additional components include surfactants, wetting agents, opacifying agents, colorants, viscosifying agents, catalysts, preservatives, fillers, diluents, hydrated compounds, halogenated compounds, acids, bases, salts, clays, co-reactants, plasticizers, borates, melamine, and curing agents, among others. These and other additional components of the coating 102 and/or its precursor composition may facilitate production, facilitate storage, facilitate processing, facilitate application, improve functional characteristics, lower costs, improve aesthetic characteristics, and/or have other benefits.

As one example of an additive component, the precursor of the coating 102 may include a plasticizer to enhance the ability of the matrix 112 to flex in response to expansion of the intumescent particles 108. Suitable plasticizers include latex polymers, such as latex polymers having hydroxyl and/or carboxyl functionality. As another example, the coating 102 may include one or more halogenated materials within the matrix 112. Suitable halogenated materials include chlorinated phosphate esters, vinylidene chloride, vinyl chloride, chlorinated paraffin, brominated bisphenol A, and brominated neopentyl alcohol. The coating 102 may further include one or more metal synergists within the matrix 112. Suitable metal synergists include zinc-containing compounds and antimony-containing compounds. The coating 102 may still further include one or more boron-containing compounds within the matrix 112.

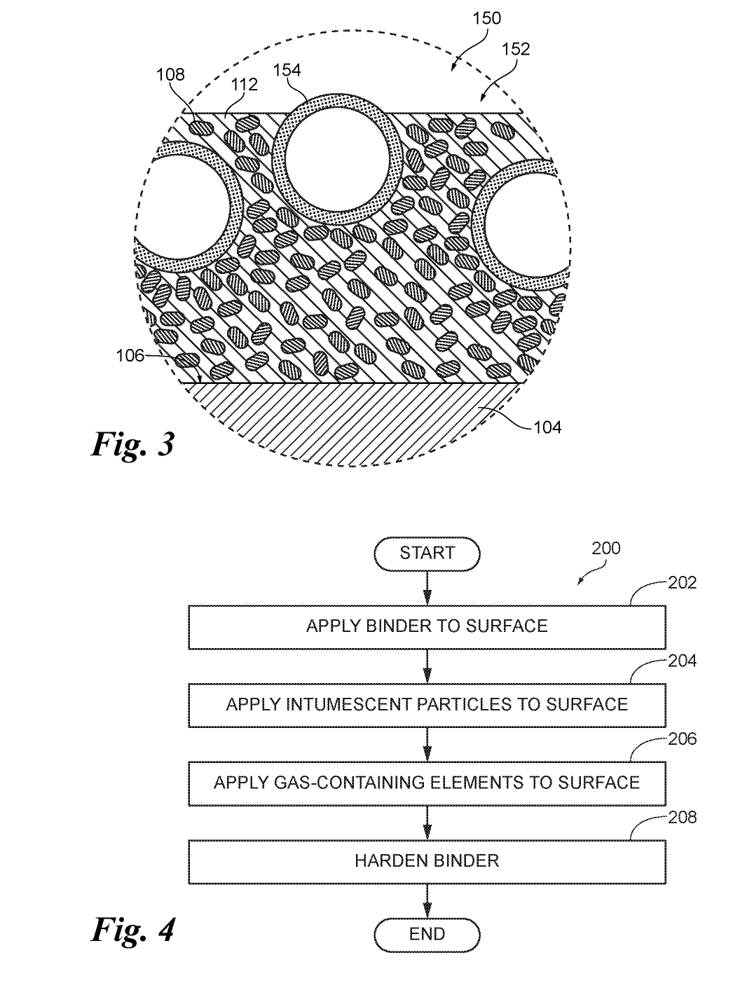

FIG. 3 is an enlarged transverse cross-sectional end view of a coating 152 of a fire-resistant wood product 150 in accordance with another embodiment of the present technology. The coating 152 can include gas-containing elements 154 that are much larger than the gas-containing elements 110 of the coating 102 shown in FIG. 2. Rather than being intermixed with the intumescent particles 108 when the binder corresponding to the matrix 112 is first applied to the substrate 104, the gas-containing elements 154 can be embedded in the binder after the binder is first applied to the substrate 104. This may displace some of the intumescent particles 108 into regions of the matrix 112 around the gas-containing elements 154.

FIG. 4 is a flow chart illustrating a method 200 for enhancing a fire-resistance of a wood-containing substrate in accordance with an embodiment of the present technology. With reference to FIGS. 1, 2 and 4 together, the method 200 can include applying a binder to the surface 106 (block 202), applying the intumescent particles 108 to the surface 106 (block 204), and applying the gas-containing elements 110 to the surface 106 (block 206). Thereafter, the method 200 can include hardening the binder to form the matrix 112 (block 208). In some cases, the intumescent particles 108, the gas-containing elements 110 and the binder are applied to the surface 106 together via the same composition. This may cause the intumescent particles 108 and/or the gas-containing elements 110 to be evenly dispersed within the matrix 112. In other cases, the binder may be applied to the surface 106 before the intumescent particles 108 and/or the gas-containing elements 110 are applied to the surface 106. This may cause the intumescent particles 108 and/or the gas-containing elements 110 to be unevenly dispersed within the matrix 112.

When the intumescent particles 108, the gas-containing elements 110, and the binder are applied to the surface 106 together via the same composition, the application level can be from 0.05 to 3.0 grams of the composition per square inch of the surface 106. Some or all of the surface 106 can be covered with the composition. For example, the method 200 can include covering from 50% to 100% of a total surface area of the substrate 104. The preferred coating application level and coverage may depend on the substrate type, the intended use of the coated substrate, and performance requirements for the coated substrate. The composition can be applied using a sprayer, an extruder, a curtain coater, a roll coater, or another suitable type of application equipment. In addition or alternatively, the composition can be applied manually, such as with a hand-held knife or brush. In some cases, the composition is applied as an even coating, such as a sprayed coating. In other cases, the composition may be applied as a series of extruded beads. For example, these beads may have an average diameter from ⅛ inch to 1 inch and may be spaced from ⅛ inch to ¼ inch apart. The beads can be allowed to cure in their applied form. Alternatively, the beads can be spread or flattened (e.g., with an air knife) prior to curing to achieve a more uniform coating thickness. Other application techniques are also possible.

The intumescent particles 108, the gas-containing elements 110, and the binder may form a relatively stable suspension having a shelf-life of at least 6 hours. Before applying this composition to the surface 106, the method 200 can include adding a curing agent to the composition. For example, when the binder includes an aminoplast resin, the curing agent may be an inorganic acid (e.g., sulfuric acid, nitric acid, or hydrochloric acid) or an organic acid (e.g., para-toluenesulfonic acid, citric acid, L-tartaric acid, or acetic acid). When the composition is aqueous, it can be advantageous for the curing agent to be a water-soluble acid. Just before application, the curing agent can be added to the composition at a ratio that promotes rapid curing of the binder component of the composition. For example, when the binder includes an aminoplast resin, the ratio of aminoplast resin to acid curing agent can be from 20:1 to 2:1 on a solids mass basis. The solids mass of a given material is the mass of the material excluding solvent (including water) and any other volatile constituents. For example, if a melamine urea formaldehyde resin is 65% solids by mass, a 1 gram sample of the resin heated in an oven at 125° C. for a period of 3 hours and 45 minutes retains about 65% of its original mass. Meter-mixing equipment can be used to combine and mix the composition and the curing agent at a suitable ratio. Manufacturers of meter-mixing equipment include Graco Inc. (Minneapolis, Minn.). In addition to or instead of adding a curing agent, the composition can be heated to accelerate curing. If a curing agent is used, the composition and curing agent may have a pot life of less than 30 minutes. In at least some cases, this pot life can be increased by decreasing the temperature of the composition or by adding a diluent.

### EXAMPLES

The following examples are provided to illustrate certain particular embodiments of the disclosure. It should be understood that additional embodiments not limited to the particular features described are consistent with the following examples.

### Example 1

### Water Durability of OSB with Conventional Coating

In this example, the ability of a conventional fire-resistant coating to resist prolonged water exposure was evaluated. The conventional fire-resistant coating (FR116) tested was a phenol/formaldehyde resin containing about 13.7% expandable graphite by weight of the total liquid formulation. The sample was prepared by charging a 600 mL glass beaker with water (170 g), 50% sodium hydroxide (aq) (7.5 g), kraft lignin powder (44 g) obtained from the Weyerhaeuser Company (Federal Way, Wash.), paraformaldehyde powder (2.5 g), a PF resin (88 g) known as 159C45 from the Georgia-Pacific Resins Corporation (Decatur, Ga.), fumed silica (3.0 g) known as Cab-O-Sil EH5 from the Cabot Corporation (Boston, Mass.), a wetting agent (0.5 g) known as Surfynol 104PA from Air Products & Chemicals (Allentown, Pa.), and expandable graphite particles (50 g) known as GrafGuard 160-50N from GrafTech International Holding Incorporated (Parma, Ohio). The contents of the beaker were stirred with a Cowles mixer subsequent to each addition. A portion of this resin mixture (97.0 g) was combined with triacetin (3.0 g) and the mixture was vigorously stirred and applied to one major surface of a section of oriented strand board (OSB) at an application rate of about 0.19 g/in² (wet basis). The sample was then placed in a ventilated oven at a temperature of 80° C. for a period of 15 minutes, which was sufficient to dry and harden the coating. The sample was then turned over and the second major surface of the section of OSB was coated with the triacetin-spiked coating formulation at an application rate of about 0.19 g/in² (wet basis). Again, the sample was transferred into a ventilated oven at a temperature of 80° C. for a period of 15 minutes, which was sufficient to dry and harden the coating. The sample was then allowed to equilibrate for a period of about two weeks prior to testing.

After equilibrating, the sample was submerged under 1 inch of water in a tank at a temperature of 20° C. for a period of 24 hours. At the end of this process, the sample was removed from the water and examined. It was estimated that about 70% of the coating had spontaneously been removed as a result of the water exposure. The coating that remained intact on the sample was soft and swollen and could easily be removed by scraping. This example demonstrates that a conventional fire-resistant coating based on a PF resin was not sufficiently durable to withstand prolonged exposure to water.

### Example 2

### Water Durability of OSB with Inventive Coating

In this example, the ability of a fire-resistant coating configured in accordance with an embodiment of the present technology to resist prolonged water exposure was evaluated. The fire-resistant coating (W2193) was prepared by charging a 1000 mL plastic beaker with a urea formaldehyde resin known as UF 253A34 (198 g) from the Georgia-Pacific Resins Corporation (Decatur, Ga.), a viscosifying agent known as Rheolate 288 (1 g) from Elementis Specialties (New Berry Springs, Calif.), a carboxylated styrene acrylic emulsion known as RayKote 444s from Specialty Polymers Inc. (Woodburn, Oreg.) (80 g), halloysite clay (3 g) from Applied Minerals, Inc. (New York, N.Y.), zinc borate (16 g) from Rio Tinto Minerals (Greenwood Village, Colo.), a phosphate ester known as Fyrol PCF (21 g) from ICL-IP America (St. Louis, Mo.), a colorant package (10 g) known as W509 from the Weyerhaeuser Company (Federal Way, Wash.), an oxazolodine known as LH-1000 (21 g) from the Angus Chemical Company (Chicago, Ill.), expandable graphite (60 g) from Asbury Carbons (Asbury, N.J.), hollow glass microspheres (25 g) from the 3M company (St. Paul, Minn.), and a solution (100 g) of urea (3 g), L-tartaric acid (25 g), and water (72 g). The contents of the beaker were stirred with a Cowles mixer subsequent to each addition. A portion of this resin mixture (61 g) was immediately applied to one major surface of a section of oriented strand board (OSB) (8″×8″) that was pre-heated to 185° F. The sample was then placed in a ventilated oven at a temperature of 185° F. for a period of 3 minutes, which was sufficient to dry and harden the coating. The sample was then allowed to equilibrate for a period of about 48 hours prior to testing. The cured coating thickness measured approximately 0.077 inch.

After equilibrating, the sample was submerged under 6 inches of water in a bucket at a temperature of 20° C. for a period of 14 hours. At the end of this process, the sample was removed from the water and examined. It was estimated that none of the coating had spontaneously been removed as a result of the water exposure. The coating was hard and could not be easily removed by scraping. This example demonstrates that a fire-resistant coating configured in accordance with an embodiment of the present technology was sufficiently durable to withstand prolonged exposure to water.

### Example 3

### Fire Test of Uncoated OSB

In this example, the fire resistance of uncoated OSB was evaluated. In particular, a section of oriented strand board (OSB) ( 7/16″×8″×8″) manufactured at a Weyerhaeuser OSB mill in Arcadia, La. was exposed to a flame from a Bunsen Burner to evaluate the fire resistance of the sample. A hole was drilled in the center of the sample to mid-thickness (approximately 0.225 inch depth). The sample was mounted above a Bunsen burner at a height of 4.56 inches above the top surface of the burner. The Bunsen burner was surrounded by fire bricks on four sides with openings for ventilation provided at the bottom. The chamber created by the bricks measured approximately 10″ deep×8″ wide×15″ high. The chamber was preheated by igniting the burner (natural gas) and burning for several minutes with a sacrificial sample in place above the burner until the temperature of the bricks was approximately 350° F. to 450° F., as measured by infrared thermometer. The OSB test sample was then mounted above the burner, supported by the bricks. A thermocouple was inserted into the pre-drilled hole to mid-thickness of the sample. The burner was ignited and the flame adjusted to a flow rate of natural gas of from 3.25 to 3.75 gallons per minute. The air inlet of the burner was adjusted to produce a distinct visible blue inner cone. The top of the outer cone contacted the bottom face of the test sample. A stopwatch was started, and the temperature of the thermocouple was monitored continuously. The times for the temperature of the thermocouple to reach 212° F. and 400° F. were utilized as measurements of the fire resistance of the sample. The time to reach 212° F. was approximately 1-2 minutes, and the time to reach 400° F. was approximately 3-4 minutes. Five examples of the results of this test are included in Table 1 below.

TABLE 1
Fire Test Results for Uncoated OSB

| | Center point | Density | Time to reach | Time to reach |
|---|---|---|---|---|
| Specimen | caliper (in) | (PCF) | 212° F. (min:sec) | 400° F. (min:sec) |
| 1 | 0.430 | 47.1 | 1:42 | 4:14 |
| 2 | 0.425 | 49.1 | 1:18 | 3:13 |
| 3 | 0.424 | 48.8 | 1:12 | 3:55 |
| 4 | 0.427 | 50.2 | 1:48 | 4:22 |
| 5 | 0.426 | 50.1 | 1:29 | 3:34 |

### Example 4

### Fire Test of OSB with Inventive Coating

In this example, the ability of a fire-resistant coating configured in accordance with an embodiment of the present technology to resist fire exposure in a lab scale test was evaluated. The fire-resistant coating (W2193) was prepared by charging a 1000 mL plastic beaker with a urea formaldehyde resin known as UF 253A34 (198 g) from the Georgia-Pacific Resins Corporation (Decatur, Ga.), a viscosifying agent known as Rheolate 288 (1 g) from Elementis Specialties (New Berry Springs, Calif.), a carboxylated styrene acrylic emulsion known as RayKote 444s from Specialty Polymers Inc. (Woodburn, Oreg.) (80 g), halloysite clay (3 g) from Applied Minerals, Inc. (New York, N.Y.), zinc borate (16 g) from Rio Tinto Minerals (Greenwood Village, Colo.), a phosphate ester known as Fyrol PCF (21 g) from ICL-IP America (St. Louis, Mo.), a colorant package (10 g) known as W509 from the Weyerhaeuser Company (Federal Way, Wash.), an oxazolodine known as LH-1000 (21 g) from the Angus Chemical Company (Chicago, Ill.), expandable graphite (60 g) known as 3772 from Asbury Carbons (Asbury, N.J.), hollow glass microspheres (25 g) known as K-1 from the 3M company (St. Paul, Minn.), and a solution (100 g) of urea (3 g), L-tartaric acid (25 g), and water (72 g). The contents of the beaker were stirred with a Cowles mixer subsequent to each addition. A portion of this resin mixture (61 g) was immediately applied to one major surface of a section of oriented strand board (OSB) (8″×8″) that was pre-heated to 185° F. The sample was then placed in a ventilated oven at a temperature of 185° F. for a period of 3 minutes, which was sufficient to dry and harden the coating. The sample was then allowed to equilibrate for a period of about 48 hours prior to testing. The cured coating thickness measured approximately 0.077 inch. The coating was subjected to the same test procedure described in Example 3 above.

TABLE 2
Fire Test Results for OSB with Inventive Coating

| | Center point | | Density | Time | Time |
|---|---|---|---|---|---|
| | caliper | Center point | prior to | to reach | to reach |
| | before | caliper after | coating | 212° F. | 400° F. |
| Specimen | coating (in) | coating (in) | (PCF) | (min:sec) | (min:sec) |
| W2193 | 0.458 | 0.532 | 45.4 | 8:32 | 22:8 |

### Example 5

### Fire Test of OSB with Inventive Coating

In this example, the ability of a fire-resistant coating configured in accordance with an embodiment of the present technology to resist fire exposure in a lab scale test was evaluated. The fire-resistant coating (W2210) was prepared by charging a 1000 mL plastic beaker with a urea formaldehyde resin known as UF 253A34 (338 g) from the Georgia-Pacific Resins Corporation (Decatur, Ga.), a viscosifying agent known as Rheolate 288 (1 g) from Elementis Specialties (New Berry Springs, Calif.), a carboxylated styrene acrylic emulsion known as RayKote 444s from Specialty Polymers Inc. (Woodburn, Oreg.) (180 g), halloysite clay (6 g) from Applied Minerals, Inc. (New York, N.Y.), zinc borate (15 g) from Rio Tinto Minerals (Greenwood Village, Colo.), a phosphate ester known as Fyrol PCF(30 g) from ICL-IP America (St. Louis, Mo.), a colorant package (10 g) known as W509 from the Weyerhaeuser Company (Federal Way, Wash.), an oxazolodine known as LH-1000 (20 g) from the Angus Chemical Company (Chicago, Ill.), expandable graphite (160 g) known as 3772 from Asbury Carbons (Asbury, N.J.), hollow glass microspheres (40 g) known as K-1 from the 3M company (St. Paul, Minn.), and a solution (200 g) of urea (9 g), L-tartaric acid (75 g), and water (216 g). The contents of the beaker were stirred with a Cowles mixer subsequent to each addition. A portion of this resin mixture (61 g) was immediately applied to one major surface of a section of oriented strand board (OSB) (8″×8″) that was pre-heated to 185° F. The sample was then placed in a ventilated oven at a temperature of 185° F. for a period of 3 minutes, which was sufficient to dry and harden the coating. The sample was then allowed to equilibrate for a period of about 48 hours prior to testing. The cured coating thickness measured approximately 0.070 inch. The coating was subjected to the same test procedure described in Example 3 above.

TABLE 3
Fire Test Results for OSB with Inventive Coating

| | Center | Center | Density | | |
|---|---|---|---|---|---|
| | point | point | prior | Time to | Time to |
| | caliper | caliper | to | reach | reach |
| | before | after | coating | 212° F. | 400° F. |
| Specimen | coating (in) | coating (in) | (PCF) | (min:sec) | (min:sec) |
| W2210 | 0.439 | 0.509 | 47.2 | 6:45 | 21:45 |

### Example 6

### Fire Test of OSB with Inventive Coating

In this example, the ability of a fire-resistant coating configured in accordance with an embodiment of the present technology to resist fire exposure in a lab scale test was evaluated. The fire-resistant coating (W2198.Q) was prepared by charging a 1000 mL plastic beaker with a urea formaldehyde resin known as UF 253A34 (118 g) from the Georgia-Pacific Resins Corporation (Decatur, Ga.), a viscosifying agent known as Rheolate 288 (1 g) from Elementis Specialties (New Berry Springs, Calif.), an elastomeric styrene acrylic emulsion known as Rayflex 765 from Specialty Polymers Inc. (Woodburn, Oreg.) (140 g), halloysite clay (3 g) from Applied Minerals, Inc. (New York, N.Y.), zinc borate (8 g) from Rio Tinto Minerals (Greenwood Village, Colo.), a phosphate ester known as Fyrol PCF(30 g) from ICL-IP America (St. Louis, Mo.), a colorant package (5 g) known as W509 from the Weyerhaeuser Company (Federal Way, Wash.), an oxazolodine known as LH-1000 (10 g) from the Angus Chemical Company (Chicago, Ill.), expandable graphite (60 g) known as 3772 from Asbury Carbons (Asbury, N.J.), hollow glass microspheres (25 g) known as K-1 from the 3M company (St. Paul, Minn.), and a solution (100 g) of urea (30 g), L-tartaric acid (250 g), and water (720 g). The contents of the beaker were stirred with a Cowles mixer subsequent to each addition. A portion of this resin mixture (61 g) was immediately applied to one major surface of a section of oriented strand board (OSB) (8″×8″) that was pre-heated to 185° F. The sample was then placed in a ventilated oven at a temperature of 185° F. for a period of 3 minutes, which was sufficient to dry and harden the coating. The sample was then allowed to equilibrate for a period of about 48 hours prior to testing. The cured coating thickness measured approximately 0.114 inch. The coating was subjected to the same test procedure described in Example 3 above.

TABLE 4
Fire Test Results for OSB with Inventive Coating

| | Center | Center | Density | | |
|---|---|---|---|---|---|
| | point | point | prior | Time to | Time to |
| | caliper | caliper | to | reach | reach |
| | before | after | coating | 212° F. | 400° F. |
| Specimen | coating (in) | coating (in) | (PCF) | (min:sec) | (min:sec) |
| W2198.Q | 0.454 | 0.568 | 48.9 | 6:40 | 18:26 |

### Example 7

### Fire Test of OSB with Inventive Coating

In this example, the ability of a fire-resistant coating configured in accordance with an embodiment of the present technology to resist fire exposure in a lab scale test was evaluated. The fire-resistant coating (W2198.P) was prepared by charging a 1000 mL plastic beaker with a urea formaldehyde resin known as UF 253A34 (118 g) from the Georgia-Pacific Resins Corporation (Decatur, Ga.), a viscosifying agent known as Rheolate 288 (1 g) from Elementis Specialties (New Berry Springs, Calif.), an elastomeric styrene acrylic emulsion known as Rayflex 765 from Specialty Polymers Inc. (Woodburn, Oreg.) (140 g), halloysite clay (3 g) from Applied Minerals, Inc. (New York, N.Y.), zinc borate (8 g) from Rio Tinto Minerals (Greenwood Village, Colo.), a phosphate ester known as Fyrol PCF(30 g) from ICL-IP America (St. Louis, Mo.), a colorant package (5 g) known as W509 from the Weyerhaeuser Company (Federal Way, Wash.), an oxazolodine known as LH-1000 (10 g) from the Angus Chemical Company (Chicago, Ill.), expandable graphite (60 g) known as 3772 from Asbury Carbons (Asbury, N.J.), hollow glass microspheres (25 g) known as K-1 from the 3M company (St. Paul, Minn.), and a solution (100 g) of urea (200 g), L-tartaric acid (250 g), and water (550 g). The contents of the beaker were stirred with a Cowles mixer subsequent to each addition. A portion of this resin mixture (61 g) was immediately applied to one major surface of a section of oriented strand board (OSB) (8″×8″) that was pre-heated to 185° F. The sample was then placed in a ventilated oven at a temperature of 185° F. for a period of 3 minutes, which was sufficient to dry and harden the coating. The sample was then allowed to equilibrate for a period of about 48 hours prior to testing. The cured coating thickness measured approximately 0.093 inch. The coating was subjected to the same test procedure described in Example 3 above.

TABLE 5
Fire Test Results for OSB with Inventive Coating

| | Center | Center | Density | | |
|---|---|---|---|---|---|
| | point | point | prior | Time to | Time to |
| | caliper | caliper | to | reach | reach |
| | before | after | coating | 212° F. | 400° F. |
| Specimen | coating (in) | coating (in) | (PCF) | (min:sec) | (min:sec) |
| W2198.P | 0.453 | 0.546 | 47.3 | 6:41 | 21:0 |

### Example 8

### Fire Test of OSB with Inventive Coating

In this example, the ability of a fire-resistant coating configured in accordance with an embodiment of the present technology to resist fire exposure in a lab scale test was evaluated. The fire-resistant coating (W2201.6A) was prepared by charging a 1000 mL plastic beaker with a urea formaldehyde resin known as UF 253A34 (178.5 g) from the Georgia-Pacific Resins Corporation (Decatur, Ga.), a viscosifying agent known as Rheolate 288 (0.5 g) from Elementis Specialties (New Berry Springs, Calif.), a carboxylated styrene acrylic emulsion known as RayKote 444s from Specialty Polymers Inc. (Woodburn, Oreg.) (80 g), halloysite clay (3 g) from Applied Minerals, Inc. (New York, N.Y.), zinc borate (8 g) from Rio Tinto Minerals (Greenwood Village, Colo.), a phosphate ester known as Fyrol PCF(30 g) from ICL-IP America (St. Louis, Mo.), a colorant package (5 g) known as W509 from the Weyerhaeuser Company (Federal Way, Wash.), an oxazolodine known as LH-1000 (10 g) from the Angus Chemical Company (Chicago, Ill.), expandable graphite (60 g) known as 3772 from Asbury Carbons (Asbury, N.J.), hollow glass microspheres (25 g) known as K-1 from the 3M company (St. Paul, Minn.), and a solution (100 g) of urea (5 g), L-tartaric acid (12 g), and water (83 g). The contents of the beaker were stirred with a Cowles mixer subsequent to each addition. A portion of this resin mixture (61 g) was immediately applied to one major surface of a section of oriented strand board (OSB) (8″×8″) that was pre-heated to 185° F. The sample was then placed in a ventilated oven at a temperature of 185° F. for a period of 3 minutes, which was sufficient to dry and harden the coating. The sample was then allowed to equilibrate for a period of about 48 hours prior to testing. The cured coating thickness measured approximately 0.101 inch. The coating was subjected to the same test procedure described in Example 3 above.

TABLE 6
Fire Test Results for OSB with Inventive Coating

| | Center | | | | |
|---|---|---|---|---|---|
| | point | Center | Density | | |
| | caliper | point | prior | Time to | Time to |
| | before | caliper | to | reach | reach |
| | coating | after | coating | 212° F. | 400° F. |
| Specimen | (in) | coating (in) | (PCF) | (min:sec) | (min:sec) |
| W2201.6A | 0.426 | 0.527 | 47.9 | 6:30 | 22:29 |

### Example 9

### Fire Test of OSB with Inventive Coating

In this example, the ability of a fire-resistant coating configured in accordance with an embodiment of the present technology to resist fire exposure in a lab scale test was evaluated. The fire-resistant coating (W2201.C) was prepared by charging a 1000 mL plastic beaker with a urea formaldehyde resin known as UF 253A34 (178.5 g) from the Georgia-Pacific Resins Corporation (Decatur, Ga.), a viscosifying agent known as Rheolate 288 (0.5 g) from Elementis Specialties (New Berry Springs, Calif.), a carboxylated styrene acrylic emulsion known as RayKote 444s from Specialty Polymers Inc. (Woodburn, Oreg.) (80 g), halloysite clay (3 g) from Applied Minerals, Inc. (New York, N.Y.), zinc borate (8 g) from Rio Tinto Minerals (Greenwood Village, Colo.), a phosphate ester known as Fyrol PCF(30 g) from ICL-IP America (St. Louis, Mo.), a colorant package (5 g) known as W509 from the Weyerhaeuser Company (Federal Way, Wash.), an oxazolodine known as LH-1000 (10 g) from the Angus Chemical Company (Chicago, Ill.), expandable graphite (60 g) known as 3772 from Asbury Carbons (Asbury, N.J.), hollow glass microspheres (25 g) known as K-1 from the 3M company (St. Paul, Minn.), and a solution (100 g) of urea (5 g), citric acid (36 g), and water (59 g). The contents of the beaker were stirred with a Cowles mixer subsequent to each addition. A portion of this resin mixture (61 g) was immediately applied to one major surface of a section of oriented strand board (OSB) (8″×8″) that was pre-heated to 185° F. The sample was then placed in a ventilated oven at a temperature of 185° F. for a period of 3 minutes, which was sufficient to dry and harden the coating. The sample was then allowed to equilibrate for a period of about 48 hours prior to testing. The cured coating thickness measured approximately 0.061 inch. The coating was subjected to the same test procedure described in Example 3 above.

TABLE 7
Fire Test Results for OSB with Inventive Coating

| | Center | Center | Density | | |
|---|---|---|---|---|---|
| | point | point | prior | Time to | Time to |
| | caliper | caliper | to | reach | reach |
| | before | after | coating | 212° F. | 400° F. |
| Specimen | coating (in) | coating (in) | (PCF) | (min:sec) | (min:sec) |
| W2201.C | 0.416 | 0.477 | 50.7 | 6:55 | 17:43 |

### Example 10

### Fire Test of OSB with Inventive Coating

In this example, the ability of a fire-resistant coating configured in accordance with an embodiment of the present technology to resist fire exposure in a lab scale test was evaluated. The fire-resistant coating (W2201.B) was prepared by charging a 1000 mL plastic beaker with a urea formaldehyde resin known as UF 253A34 (178.5 g) from the Georgia-Pacific Resins Corporation (Decatur, Ga.), a viscosifying agent known as Rheolate 288 (0.5 g) from Elementis Specialties (New Berry Springs, Calif.), a carboxylated styrene acrylic emulsion known as RayKote 444s from Specialty Polymers Inc. (Woodburn, Oreg.) (80 g), halloysite clay (3 g) from Applied Minerals, Inc. (New York, N.Y.), zinc borate (8 g) from Rio Tinto Minerals (Greenwood Village, Colo.), a phosphate ester known as Fyrol PCF(30 g) from ICL-IP America (St. Louis, Mo.), a colorant package (5 g) known as W509 from the Weyerhaeuser Company (Federal Way, Wash.), an oxazolodine known as LH-1000 (10 g) from the Angus Chemical Company (Chicago, Ill.), expandable graphite (60 g) known as 3772 from Asbury Carbons (Asbury, N.J.), hollow glass microspheres (25 g) known as K-1 from the 3M company (St. Paul, Minn.), and a solution (100 g) of urea (5 g), citric acid (24 g), and water (71 g). The contents of the beaker were stirred with a Cowles mixer subsequent to each addition. A portion of this resin mixture (61 g) was immediately applied to one major surface of a section of oriented strand board (OSB) (8″×8″) that was pre-heated to 185° F. The sample was then placed in a ventilated oven at a temperature of 185° F. for a period of 3 minutes, which was sufficient to dry and harden the coating. The sample was then allowed to equilibrate for a period of about 48 hours prior to testing. The cured coating thickness measured approximately 0.107 inch. The coating was subjected to the same test procedure described in Example 3 above.

TABLE 8
Fire Test Results for OSB with Inventive Coating

| | Center | Center | Density | | |
|---|---|---|---|---|---|
| | point | point | prior | Time to | Time to |
| | caliper | caliper | to | reach | reach |
| | before | after | coating | 212° F. | 400° F. |
| Specimen | coating (in) | coating (in) | (PCF) | (min:sec) | (min:sec) |
| W2201.B | 0.433 | 0.540 | 49.1 | 8:1 | 25:55 |

### Example 11

### Fire Test of OSB with Inventive Coating

In this example, the ability of a fire-resistant coating configured in accordance with an embodiment of the present technology to resist fire exposure in a lab scale test was evaluated. The fire-resistant coating (W2201.6C) was prepared by charging a 1000 mL plastic beaker with a urea formaldehyde resin known as UF 253A34 (178.5 g) from the Georgia-Pacific Resins Corporation (Decatur, Ga.), a viscosifying agent known as Rheolate 288 (0.5 g) from Elementis Specialties (New Berry Springs, Calif.), a carboxylated styrene acrylic emulsion known as RayKote 444s from Specialty Polymers Inc. (Woodburn, Oreg.) (80 g), halloysite clay (3 g) from Applied Minerals, Inc. (New York, N.Y.), zinc borate (8 g) from Rio Tinto Minerals (Greenwood Village, Colo.), a phosphate ester known as Fyrol PCF(30 g) from ICL-IP America (St. Louis, Mo.), a colorant package (5 g) known as W509 from the Weyerhaeuser Company (Federal Way, Wash.), an oxazolodine known as LH-1000 (10 g) from the Angus Chemical Company (Chicago, Ill.), expandable graphite (60 g) known as 3772 from Asbury Carbons (Asbury, N.J.), hollow glass microspheres (25 g) known as K-1 from the 3M company (St. Paul, Minn.), and a solution (100 g) of urea (5 g), L-tartaric acid (36 g), and water (59 g). The contents of the beaker were stirred with a Cowles mixer subsequent to each addition. A portion of this resin mixture (61 g) was immediately applied to one major surface of a section of oriented strand board (OSB) (8″×8″) that was pre-heated to 185° F. The sample was then placed in a ventilated oven at a temperature of 185° F. for a period of 3 minutes, which was sufficient to dry and harden the coating. The sample was then allowed to equilibrate for a period of about 48 hours prior to testing. The cured coating thickness measured approximately 0.127 inch. The coating was subjected to the same test procedure described in Example 3 above.

TABLE 9
Fire Test Results for OSB with Inventive Coating

| | Center | Center | Density | | |
|---|---|---|---|---|---|
| | point | point | prior | Time to | Time to |
| | caliper | caliper | to | reach | reach |
| | before | after | coating | 212° F. | 400° F. |
| Specimen | coating (in) | coating (in) | (PCF) | (min:sec) | (min:sec) |
| W2201.6C | 0.436 | 0.563 | 47.8 | 8:1 | 26:1 |

### Example 12

### Fire Test of OSB with Inventive Coating

In this example, the ability of a fire-resistant coating configured in accordance with an embodiment of the present technology to resist fire exposure in a lab scale test was evaluated. The fire-resistant coating (W2029) was prepared by charging a 1000 mL plastic beaker with a melamine urea formaldehyde resin known as 778G49 (181.6 g) from the Georgia-Pacific Resins Corporation (Decatur, Ga.), water (26.0 g), a colorant package (10 g) known as W508 from the Weyerhaeuser Company (Federal Way, Wash.), expandable graphite (40 g) known as 3772 from Asbury Carbons (Asbury, N.J.), a silica aerogel known as Enova IC 3110 Aerogel (20 g) from the Cabot Corporation (Alpharetta Ga.), an amine catalyst known as Polycat DBU (2.4 g) from Air Products (Allentown Pa.), and a polymeric isocyanate known as M2OFB (120 g) from BASF Corporation (Wyandotte Mich.). The contents of the beaker were stirred subsequent to each addition. A portion of this resin mixture (76.8 g) was immediately applied to one major surface of a section of oriented strand board (OSB) (8″×8″). The sample was stored at a temperature of approximately 20° C. for a period of about 48 hours. During this period the coating solidified. The coating was subjected to the same test procedure described in Example 3 above.

TABLE 10
Fire Test Results for OSB with Inventive Coating

| | Center | Center | Density | | |
|---|---|---|---|---|---|
| | point | point | prior | Time to | Time to |
| | caliper | caliper | to | reach | reach |
| | before | after | coating | 212° F. | 400° F. |
| Specimen | coating (in) | coating (in) | (PCF) | (min:sec) | (min:sec) |
| W2029 | — | — | — | 7:14 | 22:16 |

### Example 13

### Fire Test of OSB with Inventive Coating

In this example, the ability of a fire-resistant coating configured in accordance with an embodiment of the present technology to resist fire exposure in a lab scale test was evaluated. The fire-resistant coating (W2028) was prepared by charging a 1000 mL plastic beaker with a melamine urea formaldehyde resin known as 778G49 (181.6 g) from the Georgia-Pacific Resins Corporation (Decatur, Ga.), water (12 g), an ammonium acrylate dispersant (2.2 g) known as Dispex AA 4040NS from BASF (Florham Park, N.J.), diethanol amine (1.8 g), halloysite clay (30 g) from Applied Minerals, Inc. (New York, N.Y.), a colorant package (10 g) known as W508 from the Weyerhaeuser Company (Federal Way, Wash.), expandable graphite (40 g) known as 3772 from Asbury Carbons (Asbury, N.J.), an amine catalyst known as Polycat DBU (2.4 g) from Air Products (Allentown Pa.), and a polymeric isocyanate known as M2OFB (120 g) from BASF Corporation (Wyandotte Mich.). The contents were stirred with a Cowles mixer subsequent to each addition. A portion of this resin mixture (76.8 g) was immediately applied to one major surface of a section of oriented strand board (OSB) (8″×8″). The sample was stored at a temperature of approximately 20° C. for a period of about 48 hours. During this period the coating solidified. The coating was subjected to the same test procedure described in Example 3 above.

TABLE 11
Fire Test Results for OSB with Inventive Coating

| | Center | Center | Density | | |
|---|---|---|---|---|---|
| | point | point | prior | Time to | Time to |
| | caliper | caliper | to | reach | reach |
| | before | after | coating | 212° F. | 400° F. |
| Specimen | coating (in) | coating (in) | (PCF) | (min:sec) | (min:sec) |
| W2028 | — | — | — | 5:45 | 20:59 |

### Example 14

### Fire Test of OSB with Inventive Coating

In this example, the ability of a fire-resistant coating configured in accordance with an embodiment of the present technology to resist fire exposure in a lab scale test was evaluated. The fire-resistant coating (W2076) was prepared by charging a 1000 mL plastic beaker a urea formaldehyde resin known as 252A63 (326 g) from the Georgia-Pacific Resins Corporation (Decatur, Ga.), water (16 g), a colorant package (6 g) known as W509 from the Weyerhaeuser Company (Federal Way, Wash.), hollow glass microspheres (20 g) known as K-1 from the 3M company (St. Paul, Minn.), and a solution (32 g) of citric acid (50 g) and water (50 g). The contents of the beaker were stirred with a Cowles mixer subsequent to each addition. A portion of this resin mixture (128 g) was immediately applied to one major surface of a section of oriented strand board (OSB) (8″×8″). The sample was stored at a temperature of approximately 20° C. for a period of about 48 hours. During this period the coating solidified. The coating was subjected to the same test procedure described in Example 3 above.

TABLE 12
Fire Test Results for OSB with Inventive Coating

| | Center | Center | Density | | |
|---|---|---|---|---|---|
| | point | point | prior | Time to | Time to |
| | caliper | caliper | to | reach | reach |
| | before | after | coating | 212° F. | 400° F. |
| Specimen | coating (in) | coating (in) | (PCF) | (min:sec) | (min:sec) |
| W2076 | 0.427 | — | 46.9 | 8:22 | 12:32 |

### Example 15

### Fire Test of OSB with Inventive Coating

In this example, the ability of a fire-resistant coating configured in accordance with an embodiment of the present technology to resist fire exposure in a lab scale test was evaluated. The fire-resistant coating (W2073) was prepared by charging a 1000 mL plastic beaker with castor oil (217 g), an amine catalyst known as Polycat DBU (1.7 g) from Air Products (Allentown Pa.), antimony trioxide (6.2 g), a brominated compound known as SaFRon 6605 (29 g) from ICL-IP America (St. Louis, Mo.), a colorant package (21.6 g) known as Gold 101 from the Weyerhaeuser Company (Federal Way, Wash.), a fumed silica known as Cab-O-Sil EH5 (0.97 g) from Cabot Corporation (Alpharetta Ga.), a vinyl dimethoxy silane known as Silquest A-171 (13.1 g) from Momentive Specialty Chemicals (Collumbus Ohio), hollow glass microspheres (30 g) known as K-1 from the 3M company (St. Paul, Minn.), expandable graphite (60 g) known as 3772 from Asbury Carbons (Asbury, N.J.), and a polymeric isocyanate known as M2OFB (120 g) from BASF Corporation (Wyandotte Mich.). A portion of this resin mixture (35.2 g) was immediately applied to one major surface of a section of oriented strand board (OSB) (8″×8″). The sample was stored at a temperature of approximately 20° C. for a period of about 48 hours. During this period the coating solidified. The coating was subjected to the same test procedure described in Example 3 above.

TABLE 13
Fire Test Results for OSB with Inventive Coating

| | Center | Center | Density | | |
|---|---|---|---|---|---|
| | point | point | prior | Time to | Time to |
| | caliper | caliper | to | reach | reach |
| | before | after | coating | 212° F. | 400° F. |
| Specimen | coating (in) | coating (in) | (PCF) | (min:sec) | (min:sec) |
| W2073 | 0.449 | — | 49.6 | 5:45 | 17:2 |

### Example 16

### Fire Test of OSB with Inventive Coating

In this example, the ability of a fire-resistant coating configured in accordance with an embodiment of the present technology to resist fire exposure in a lab scale test was evaluated. The fire-resistant coating (W2054) was prepared by charging a 1000 mL plastic beaker with a hydroxyl functional styrene acrylic emulsion known as RayKote 1413H (225.4 g) from Specialty Polymers Inc. (Woodburn, Oreg.) (225.4 g), a high-solids methylated melamine resin known as Cymel 3106 (97 g) from Allnex Chemicals (Alpharetta, Ga.), water (10 g), a colorant package (8 g) known as W509 from the Weyerhaeuser Company (Federal Way, Wash.), hollow glass microspheres (20 g) known as K-1 from the 3M company (St. Paul, Minn.), and expandable graphite (50 g) known as 3772 from Asbury Carbons (Asbury, N.J.). A portion of this resin mixture (76.8 g) was immediately applied to one major surface of a section of oriented strand board (OSB) (8″×8″). The sample was stored at a temperature of approximately 20° C. for a period of about 48 hours. During this period the coating solidified. The coating was subjected to the same test procedure described in Example 3 above.

TABLE 14
Fire Test Results for OSB with Inventive Coating

| | Center | Center | Density | | |
|---|---|---|---|---|---|
| | point | point | prior | Time to | Time to |
| | caliper | caliper | to | reach | reach |
| | before | after | coating | 212° F. | 400° F. |
| Specimen | coating (in) | coating (in) | (PCF) | (min:sec) | (min:sec) |
| W2054 | 0.469 | — | 49.8 | 8:30 | 25:38 |

### Example 17

### Fire Test of OSB with Inventive Coating

In this example, the ability of a fire-resistant coating configured in accordance with an embodiment of the present technology to resist fire exposure in a lab scale test was evaluated. The fire-resistant coating (W2012) was prepared by charging a 1000 mL plastic beaker with a liquid phenol formaldehyde resin known as 155C42 (212 g) Georgia-Pacific Resins Corporation (Decatur, Ga.), hollow glass microspheres (28 g) known as K-1 from the 3M company (St. Paul, Minn.), expandable graphite (40 g) known as 3772 from Asbury Carbons (Asbury, N.J.), and a polymeric isocyanate known M20FB (120 g) from BASF Corporation (Wyandotte Mich.). A portion of this resin mixture (76.8 g) was immediately applied to one major surface of a section of oriented strand board (OSB) (8″×8″). The sample was stored at a temperature of approximately 20° C. for a period of about 48 hours. During this period the coating solidified. The coating was subjected to the same test procedure described in Example 3 above.

TABLE 15
Fire Test Results for OSB with Inventive Coating

| | Center | Center | Density | | |
|---|---|---|---|---|---|
| | point | point | prior | Time to | Time to |
| | caliper | caliper | to | reach | reach |
| | before | after | coating | 212° F. | 400° F. |
| Specimen | coating (in) | coating (in) | (PCF) | (min:sec) | (min:sec) |
| W2012 | — | — | — | 7:56 | 22:20 |

### Example 18

### Fire Test of OSB with Inventive Coating

In this example, the ability of a fire-resistant coating configured in accordance with an embodiment of the present technology to resist fire exposure in a lab scale test was evaluated. The fire-resistant coating (W2043) was prepared by charging a 1000 mL plastic beaker with an acrylic latex polymer known as RayCryl 1020 (161.0 g) from Specialty Polymers Inc. (Woodburn, Oreg.), a styrene acrylic latex polymer known as RayTech1175 (161.0 g) from Specialty Polymers Inc. (Woodburn, Oreg.), a colorant package (8 g) known as W509 from the Weyerhaeuser Company (Federal Way, Wash.), hollow glass microspheres (20 g) known as K-1 from the 3M company (St. Paul, Minn.), and expandable graphite (50 g) known as 3772 from Asbury Carbons (Asbury, N.J.). A portion of this resin mixture (76.8 g) was immediately applied to one major surface of a section of oriented strand board (OSB) (8″×8″). The sample was stored at a temperature of approximately 20° C. for a period of about 48 hours. During this period the coating solidified. The coating was subjected to the same test procedure described in Example 3 above.

TABLE 16
Fire Test Results for OSB with Inventive Coating

| | Center | Center | Density | | |
|---|---|---|---|---|---|
| | point | point | prior | Time to | Time to |
| | caliper | caliper | to | reach | reach |
| | before | after | coating | 212° F. | 400° F. |
| Specimen | coating (in) | coating (in) | (PCF) | (min:sec) | (min:sec) |
| W2043 | 0.442 | — | 44.5 | 6:42 | 18:5 |

### Example 19

### Fire Test of OSB with Inventive Coating

In this example, the ability of a fire-resistant coating configured in accordance with an embodiment of the present technology to resist fire exposure in a lab scale test was evaluated. The fire-resistant coating (W2199) was prepared by charging a 1000 mL plastic beaker with a urea formaldehyde resin known as UF 253A34 (310 g) from the Georgia-Pacific Resins Corporation (Decatur, Ga.), a viscosifying agent known as Rheolate 288 (2.0 g) from Elementis Specialties (New Berry Springs, Calif.), a carboxyl functional latex polymer known as RayKote 444S (159.7 g) from Specialty Polymers Inc. (Woodburn, Oreg.), halloysite clay (6 g) from Applied Minerals, Inc. (New York, N.Y.), zinc borate (16 g) from Rio Tinto Minerals (Greenwood Village, Colo.), a phosphate ester known as Fyrol PCF (100.2 g) from ICL-IP America (St. Louis, Mo.), an oxazolodine known as LH-1000 (20.1 g) from the Angus Chemical Company (Chicago, Ill.), a colorant package (10.1 g) known as W509 from the Weyerhaeuser Company (Federal Way, Wash.), hollow glass microspheres (44.9 g) known as K-1 from the 3M company (St. Paul, Minn.), expandable graphite (120 g) known as 3772 from Asbury Carbons (Asbury, N.J.), and a solution (195 g) of L-tartaric acid (500.2 g), water (1440.6 g), and urea (30.5 g). The contents of the beaker were stirred with a Cowles mixer subsequent to each addition. A portion of this resin mixture (61 g) was immediately applied to one major surface of a section of oriented strand board (OSB) (8″×8″) that was pre-heated to 185° F. The sample was then placed in a ventilated oven at a temperature of 185° F. for a period of 3 minutes, which was sufficient to dry and harden the coating. The sample was then allowed to equilibrate for a period of about 48 hours prior to testing. The cured coating thickness measured approximately 0.141 inch. The coating was subjected to the same test procedure described in Example 3 above.

TABLE 17
Fire Test Results for OSB with Inventive Coating

| | Center | Center | Density | | |
|---|---|---|---|---|---|
| | point | point | prior | Time to | Time to |
| | caliper | caliper | to | reach | reach |
| | before | after | coating | 212° F. | 400° F. |
| Specimen | coating (in) | coating (in) | (PCF) | (min:sec) | (min:sec) |
| W2199 | 0.457 | 0.598 | 46.0 | 7:39 | 25:30 |

### Summary of Examples 3-19

Selected characteristics of the samples described in Examples 3-19 above and the corresponding fire test results for these samples are summarized in Table 18 below.

TABLE 18
Summary Table

| | Coating | | | | | | |
|---|---|---|---|---|---|---|---|
| | application | Coating | Gas- | | | Time to | Time to |
| | level (g/in²) | thickness | containing | Intumescent | | reach 212° F. | reach 400° F. |
| Specimen | (“A”) | (in) | elements | particles | Resin matrix | (sec) (“B”) | (sec) (“C”) |
| Uncoated | 0 | — | — | — | — | 60-120 | 180-240 |
| W2193 | 0.95 | 0.077 | Glass | Expandable | UF (41.4%), | 512 | 1328 |
| | | | Bubbles | Graphite | Acrylic | B/A = 539 | C/A = 1398 |
| | | | (8.02%) | (19.3%) | polymer | | |
| | | | | | (14.1%) | | |
| W2210 | 0.95 | 0.070 | Glass | Expandable | UF (34.6%), | 405 | 1305 |
| | | | Bubbles | Graphite | Acrylic | B/A = 426 | C/A = 1374 |
| | | | (6.31%) | (25.2%) | polymer | | |
| | | | | | (14.2%) | | |
| W2198.Q | 0.95 | 0.114 | Glass | Expandable | UF (24.8%), | 400 | 1108 |
| | | | Bubbles | Graphite | acrylic | B/A = 421 | C/A = 1166 |
| | | | (8.07%) | (19.4%) | polymer | | |
| | | | | | (22.6%) | | |
| W2198.P | 0.95 | 0.093 | Glass | Expandable | UF (39.2%), | 401 | 1260 |
| | | | Bubbles | Graphite | acrylic | B/A = 422 | C/A = 1326 |
| | | | (7.61%) | (18.3%) | polymer | | |
| | | | | | (12.2%) | | |
| W2201.6A | 0.95 | 0.101 | Glass | Expandable | UF (37.7%), | 390 | 1349 |
| | | | Bubbles | Graphite | acrylic | B/A = 411 | C/A = 1420 |
| | | | (8.12%) | (19.5%) | polymer | | |
| | | | | | (13.0%) | | |
| W2201.C | 0.95 | 0.061 | Glass | Expandable | UF (35.0%), | 415 | 1063 |
| | | | Bubbles | Graphite | acrylic | B/A = 437 | C/A = 1119 |
| | | | (7.54%) | (18.1%) | polymer | | |
| | | | | | (12.1%) | | |
| W2201B | 0.95 | 0.107 | Glass | Expandable | UF (36.3%), | 481 | 1555 |
| | | | Bubbles | Graphite | acrylic | B/A = 506 | C/A = 1637 |
| | | | (7.82%) | (18.8%) | polymer | | |
| | | | | | (12.5%) | | |
| W2201.6C | 0.95 | 0.127 | Glass | Expandable | UF (36.3%), | 481 | 1561 |
| | | | Bubbles | Graphite | acrylic | B/A = 506 | C/A = 1643 |
| | | | (7.82%) | (18.8%) | polymer | | |
| | | | | | (12.5%) | | |
| W2029 | 1.2 | — | Aerogel | Expandable | MUF | 434 | 1336 |
| | | | (6.55%) | Graphite | (38.7%), | B/A = 362 | C/A = 1113 |
| | | | | (13.1%) | Urethane | | |
| | | | | | (39.3%) | | |
| W2028 | 1.2 | — | None | Expandable | MUF | 345 | 1216 |
| | | | | Graphite | (37.1%), | B/A = 288 | C/A = 1013 |
| | | | | (12.6%) | Urethane | | |
| | | | | | (37.7%) | | |
| W2076 | 2.0 | — | Glass | None | UF (84.5%) | 502 | 752 |
| | | | Bubbles | | | B/A = 251 | C/A = 376 |
| | | | (7.97%) | | | | |
| W2073 | 0.55 | Coating | Glass | Expandable | Urethane | 345 | 1022 |
| | | application | Bubbles | Graphite | (67.5%) | B/A = 627 | C/A = 1858 |
| | | level was | (6.00%) | (12.0%) | | | |
| | | about 50% | | | | | |
| | | of the other | | | | | |
| | | formulations | | | | | |
| | | in this table | | | | | |
| W2054 | 1.2 | — | Glass | Expandable | Melamine | 510 | 1538 |
| | | | Bubbles | Graphite | crosslinked | B/A = 425 | C/A = 1282 |
| | | | (7.10%) | (17.8%) | Acrylic latex | | |
| | | | | | (73.7%) | | |
| W2012 | 1.2 | — | Glass | Expandable | PF/pMDI | 476 | 1340 |
| | | | Bubbles | Graphite | Hybrid resin | B/A = 397 | C/A = 1117 |
| | | | (13.6%) | (19.4%) | (67.0%) | | |
| W2043 | 1.2 | — | Glass | Expandable | Acrylic latex | 404 | 1130 |
| | | | Bubbles | Graphite | polymer | B/A = 337 | C/A = 942 |
| | | | (8.51%) | (21.3%) | (68.5%) | | |
| W2199 | 0.95 | 0.141 | Glass | Expandable | UF/Acrylic | 459 | 1530 |
| | | | Bubbles | Graphite | (47.4%) | B/A = 483 | C/A = 1611 |
| | | | (7.74%) | (20.6%) | | | |

The data shown in Table 18 illustrate the surprisingly good performance of fire-resistant coatings including gas-containing elements and intumescent particles. For example, the ratio of time to reach 212° F. to coating application level (“B/A” in Table 18) is significantly lower for specimens W2028 and W2076 than it is for any of the other specimens. W2028 is the only specimen to include intumescent particles without gas-containing elements. Similarly W2076 is the only specimen to include gas-containing elements without intumescent particles. The lower ratios for the W2028 and W2076 specimens correspond to a major difference in performance because fire resistance does not vary linearly with coating application level. Achieving the same increment of increased fire resistance requires ever increasing increments of coating application weights as the degree of fire resistance increases. Thus, the markedly superior performance of the specimens including both gas-containing elements and intumescent particles relative to the W2028 and W2076 specimens suggests that gas-containing elements and intumescent particles have a special synergy in the context of fire-resistant coatings.

### CONCLUSION

This disclosure is not intended to be exhaustive or to limit the present technology to the precise forms disclosed herein. Although specific embodiments are disclosed herein for illustrative purposes, various equivalent modifications are possible without deviating from the present technology, as those of ordinary skill in the relevant art will recognize. In some cases, well-known structures and functions have not been shown and/or described in detail to avoid unnecessarily obscuring the description of the embodiments of the present technology. Although steps of methods may be presented herein in a particular order, in alternative embodiments the steps may have another suitable order. Similarly, certain aspects of the present technology disclosed in the context of particular embodiments can be combined or eliminated in other embodiments. Furthermore, while advantages associated with certain embodiments may have been disclosed in the context of those embodiments, other embodiments may also exhibit such advantages, and not all embodiments need necessarily exhibit such advantages or other advantages disclosed herein to fall within the scope of the present technology.

Throughout this disclosure, the singular terms “a,” “an,” and “the” include plural referents unless the context clearly indicates otherwise. Similarly, unless the word “or” is expressly limited to mean only a single item exclusive from the other items in reference to a list of two or more items, then the use of “or” in such a list is to be interpreted as including (a) any single item in the list, (b) all of the items in the list, or (c) any combination of the items in the list. Additionally, the terms “comprising” and the like are used throughout this disclosure to mean including at least the recited feature(s) such that any greater number of the same feature(s) and/or one or more additional types of features are not precluded. Directional terms, such as “upper,” “lower,” “front,” “back,” “vertical,” and “horizontal,” may be used herein to express and clarify the relationship between various elements. It should be understood that such terms do not denote absolute orientation. Reference herein to “one embodiment,” “an embodiment,” or similar formulations means that a particular feature, structure, operation, or characteristic described in connection with the embodiment can be included in at least one embodiment of the present technology. Thus, the appearances of such phrases or formulations herein are not necessarily all referring to the same embodiment. Furthermore, various particular features, structures, operations, or characteristics may be combined in any suitable manner in one or more embodiments of the present technology.

I/We claim:

1. A composition for increasing the fire resistance of a wood product, the composition comprising:
intumescent particles;
gas-containing elements; and
a binder in which the intumescent particles and the gas-containing elements are dispersed,
wherein the composition is configured to form a coating in which the intumescent particles are present at a concentration of at least 1% by mass, and the gas-containing elements are present at a concentration of at least 0.5% by mass.

2. The composition of claim 1 wherein:
the binder is curable from a liquid state in the composition to a solid state in the coating; and
the binder in the solid state has a Young's modulus of at least 7 GPa.

3. The composition of claim 1 wherein the binder includes a thermosetting polymer.

4. The composition of claim 1 wherein the binder includes urea-formaldehyde resin.

5. The composition of claim 1 wherein the intumescent particles are present at a concentration from 5% to 40% by mass in the coating.

6. The composition of claim 1 wherein the intumescent particles include expandable graphite.

7. The composition of claim 1 wherein the gas-containing elements are present at a concentration from 1% to 15% by mass in the coating.

8. The composition of claim 1 wherein the gas-containing elements individually include:
a shell; and
gas within the shell.

9. The composition of claim 8 wherein the shell consists essentially of inorganic material.

10. The composition of claim 1 wherein the gas-containing elements individually include:
a porous structure; and
gas within the porous structure.

11. The composition of claim 1 wherein the gas-containing elements have a melt point of at least 200° C.

12. The composition of claim 1 wherein the gas-containing elements have a true density from 0.05 to 0.70 gram per cubic centimeter.

13. The composition of claim 1 wherein the gas-containing elements are substantially spherical and have an average diameter from 10 to 200 microns.

14. A fire-resistant wood product, comprising:
a wood-containing substrate having a surface; and
a coating overlying the surface of the substrate, wherein the coating includes—
at least 5% by mass intumescent particles,
at least 1% by mass gas-containing elements, and
a polymeric matrix in which the intumescent particles and the gas-containing elements are at least partially embedded.

15. The wood product of claim 14 wherein the polymeric matrix has a Young's modulus of at least 7 GPa.

16. The wood product of claim 14 wherein the polymeric matrix includes cured formaldehyde resin.

17. The wood product of claim 14 wherein the coating has an average thickness from 1 to 6 millimeters.

18. A method for enhancing the fire-resistance of a wood-containing substrate, the method comprising:
applying a binder to a surface of a wood-containing substrate;
applying intumescent particles to the surface;
applying gas-containing elements to the surface; and
hardening the binder to form a matrix in which the intumescent particles and the gas-containing elements are at least partially embedded.

19. The method of claim 18 wherein applying the binder, the intumescent particles, and the gas-containing elements includes applying the binder, the intumescent particles, and the gas-containing elements via a composition including the intumescent particles and the gas-containing elements dispersed within the binder.

20. The method of claim 19 wherein applying the composition includes applying the composition at an average application level from 0.05 to 3.0 grams per square inch of the surface.
